(19) United States
(12) Patent Application Publication
(10) Pub. No.: US 2004/0217066 A1
(43) Pub. Date: Nov. 4, 2004

(54) Universal piping apparatus for use with a filtration device

(76) Inventor: Joseph A. Morgan JR., Charlotte, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/755,952

(22) Filed: Jan. 13, 2004

Related U.S. Application Data
(63) Continuation-in-part of application No. 10/342,422, filed on Jan. 13, 2003.
(60) Provisional application No. 60/442,498, filed on Jan. 24, 2003.
(60) Provisional application No. 60/347,763, filed on Jan. 11, 2002.

(51) Int. Cl. B01D 35/22

(52) U.S. Cl. 210/739; 210/791; 210/411; 210/798; 210/427; 210/136

(57) ABSTRACT

A piping apparatus for use with a filtration device, the piping apparatus easily allowing a plurality of fluid sources interchangeably used for backwashing the filtration device. The piping apparatus consists of an inlet conduit, an outlet conduit and a process conduit, and at least one additional conduit. In normal operation, process fluid flows into from the process conduit to the inlet conduit, into the filtration device, and out the outlet conduit for reuse in the attached process. Backwashing is accomplished by forcing fluid from either the process conduit or the additional conduit through the outlet conduit into the filtration device and then out of the inlet conduit. A plurality of backwash sources are provided such that an operator can selectably choose between the plurality of backwash fluids. A system of valves and actuators are provided to direct flow into the selected conduits, and to prevent cross-contamination of the backwash sources.

### CROSS REFERENCE TO RELATED APPLICATION

This application claims the benefit of the Provisional Application Ser. No. 60/442,498 filed on Jan. 24, 2003, and is a continuation in part of U.S. application Ser. No. 10/342,422, filed on Jan. 13, 2003, which claims the benefit of U.S. Provisional Application No. 60/347,763, filed on Jan. 11, 2002.

### FIELD OF THE INVENTION

The present invention relates to a method and apparatus for controlling the flow of a fluid within a piping apparatus, and more particularly to a piping apparatus that controls the flow of a fluid for backwashing a filter.

### BACKGROUND OF THE INVENTION

In the past, fluid from cooling towers was directly discharged without the benefit of treatment or recycling for reuse the cooling tower. However, since the 1970's, such discharge has been subject to EPA pre-treatment standards and NPDES effluent limitations, as well as local regulations. Additionally, such “once through” fluid usage leads to high fluid and sewerage cost.

In response to regulatory restrictions and fluid cost, fluid filtration devices have been developed to treat cooling tower discharge for recycling back to the cooling tower. It is important that the fluid quality from such treatment devices be sufficient to prevent scaling, erosion, and biological fouling in the cooling tower. Of particular importance is the removal efficiency of suspended solids. The concentration of suspended solids in cooling tower inlet fluid affects the number of times that the fluid can be recycled before solids precipitate from solution. Clearly, fluid with high initial suspended solids can be recycled only a minimal number of times before precipitation occurs in comparison to more purified fluid.

A common treatment device that provides full flow filtration of process fluid from a cooling tower is a sand bed filters. During normal operation, fluid flows into the filter inlet at and through the pumping apparatus to the inlet on the top of the tank. The fluid is then sprayed out over a bed of filter media, that can be sand or other media known in the art. The fluid then percolates down through the filter media to the exit piping. There, it flows to the filter outlet, where it is pumped for reuse in the cooling tower or other application.

Due to large quantities of dissolved solids and other contaminants in the fluid that accrue in the filter media during the normal operation cycle, there are a finite number of circulations that can be made by the fluid. When solid and contaminant concentration increases, the pressure at which the pump must operate increases. Also, the amount of throughput in the filter decreases. When this reaches a predefined critical level, a backwash cycle is signaled.

During the backwash cycle, fluid is not pumped through the filter media in the normal downward direction. Instead, the effluent is pumped up through the bottom of the filter media, entering the filtration tank from what is the “exit piping” in normal operation. The fluid is pumped back up through the filter media at a rate slow enough that it will not cause undue disturbance therein, and result in the unwanted disposal of the filter media. However, the upward action of the fluid is sufficient to remove any trapped solids and contaminants from the filter media. When the backwash reaches the “entrance hole, it is pumped out, and directed a waste valve that purges the backwash fluid from the system.

Depending on the availability of a fluid supply from the external, it is sometimes advantageous to backwash the filter media with external fluid or process fluid. Interchange from one fluid source to another usually requires extensive retooling of the pumping apparatus, and downtime for the cooling tower.

For example, if external fluid becomes available after operation of the treatment filter, it is often desirable to convert the piping apparatus in order to utilize the external fluid for backwashing. Backwashing with external fluid is advantageous since it is clear or suspended solids. In contrast, by backwashing with processed fluid from the cooling tower, suspended solids within the process fluid are introduced into the filter media during backwashing. As such, some of the solids may become impregnated into the filter media. Another example, that is typical of filtration device startup, the initial process fluid contains a very high amount of solids. This concentration of solids within the process fluid decreases after the cooling tower has been used for a while. As such, it would be desirable to utilize external fluid for backwashing during the break-in period for the cooling tower, and then utilize process fluid from the cooling tower for backwashing once the cooling tower break-in period is completed. Such ability to switch between external fluid and cooling tower process fluid for backwashing allows for the clean external fluid to be used when the process fluid contains the highest amounts of solids, and for the process fluid, once cleaner, to be used in order to save on the cost of fluid usage.

What is needed is for a piping apparatus that is adapted for use with a filtration device, wherein the piping apparatus easily allows external fluid or process fluid to be interchangeably used for backwashing the filtration device.

### DESCRIPTION OF THE PRIOR ART

Applicant is aware of the following U.S. patent concerning an apparatus using a filter media for treating fluid:

| U.S. Pat. No. | Issue Date | Inventor | Title |
|---|---|---|---|
| 4,141,824 | Feb. 27, 1979 | Smith | Tangentially fed |
| | | | upflow sand filter |
| | | | method and apparatus |
| U.S. App | Jan. 13, 2002 | Morgan et al. | Tangentially Fed |
| 10/342,422 | | | Meida Filter and |
| | | | Apparatus |

Smith, U.S. Pat. No. 4,141,824, discloses an apparatus for purifying fluid by filtration in which fluid is passed upwardly through one or more sand beds supported in a tower, at a slow rate so that the sand bed in not disturbed. Fluid feed to each tower is accomplished by tangentic flow from an inlet. Backwash of the sand bed is accomplished by opening a duct valve at the coned lower end which forms the base of the tower in which the sand bed is supported. Bacterial activity in the lower part of the sand bed is controlled to enhance purification of the fluid. Additionally, chemical treatment of the fluid may be used in conjunction with filtration to further treat the fluid.

Morgan et al., U.S. application Ser. No. 10/342,422, discloses a fluid treatment device for purifying process fluid by filtration wherein process fluid is tangentially introduced and caused to swirl in the housing above a filter media, before passing downwards through silica and gravel beds. The swirling increases the through capacity of the treatment device and reduces the amount of particles that would otherwise become imbedded in the filter media. Backwashing is accomplished by forcing fluid, through first and second components of the fluidizer, into the filter media. The first component is a channel formed in the manifold which provides backwash fluid to the bottom of the gravel bed. The second component provides backwash fluid at the gravel bed—silica bed interface by a series of radially spaced fluidizer arms. The fluidizer manifold provides complete fluidization of the filter media such that the filter media does not have no flow, or low flow, areas.

### SUMMARY OF THE INVENTION

The present invention is a piping apparatus that is adapted for use with a filtration device, wherein the piping apparatus easily allows source or process fluids to be interchangeably used for reversing the flow in a filtration device. It will enable easy conversion from one source of flow to another either by a slight piping modification or as an individual unit with dual source modes integral to the system. This invention can be integral to or separate from the filtration system.

### OBJECTS OF THE INVENTION

The principal object of the invention is to provide an improved method for facilitating the backwash of a fluid treatment facility.

The another object of the invention is to provide an improved method for facilitating the backwash of a fluid treatment facility, whereby the backwash effluent can be easily alternated between a external fluid source and a process fluid source.

Another object of the invention is to provide an improved piping apparatus that facilitates the easy switching from a external fluid backwash source to a process fluid backwash source.

Another object of the invention is to provide a fluid treatment device utilizing this improved piping apparatus for removing suspended solids from process fluid.

A further object of the present invention is to provide a fluid treatment device utilizing this improved piping apparatus that efficiency removes suspended solids, including those of small diameter.

Another object of the invention is to within one system provide the capability to use either an external or source fluid for backwash in a single system. A result of this is that the system can move from one source to another source of backwash fluid by either manually moving a valve or by repositioning a switch on the control panel.

A further object within this arrangement is to be able, by using any number of monitoring devices (such as a conductivity meter), to have the control system automatically select the source of backwash fluid.

### BRIEF DESCRIPTION OF THE DRAWINGS

The foregoing and other objects will be become more readily apparent by referring to the following detailed description and the appended drawings in which:

FIG. 1 is a front view of the invented fluid treatment device and piping assembly;

FIG. 2 is a side view of the fluid treatment device and piping assembly of FIG. 1;

FIG. 3 is a simplified schematic of the piping assembly of FIGS. 1 and 2, depicting the liquid media flow during normal operation of the fluid treatment device and piping assembly.

FIG. 4 is a simplified schematic of the piping assembly of FIGS. 1 and 2, depicting the liquid media flow through the fluid treatment device and piping assembly in a process fluid backwash configuration.

FIG. 5 is a simplified schematic of the piping assembly of FIGS. 1 and 2, depicting the liquid media flow through the fluid treatment device and piping assembly in an external fluid backwash configuration.

### DETAILED DESCRIPTION

The present invention is a filtration treatment device having a filter media for purifying a fluid. Not to be construed as limiting, the treatment device is typically employed to treat process fluid from a cooling tower for reuse by the cooling tower. The filter media effectively removes suspended solids from the process fluid. Periodically, the filter media is backwashed in order to remove captured solids therefrom. The device is configured to provide superior solids removal during backwashing thereby increasing the effective life of the filter media.

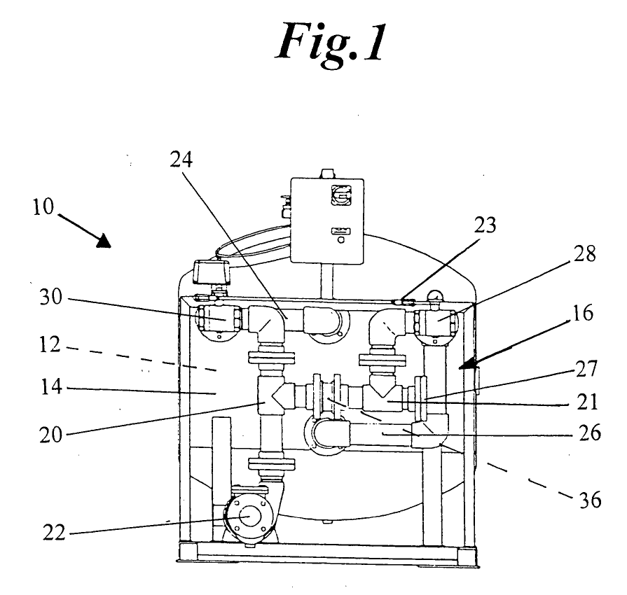

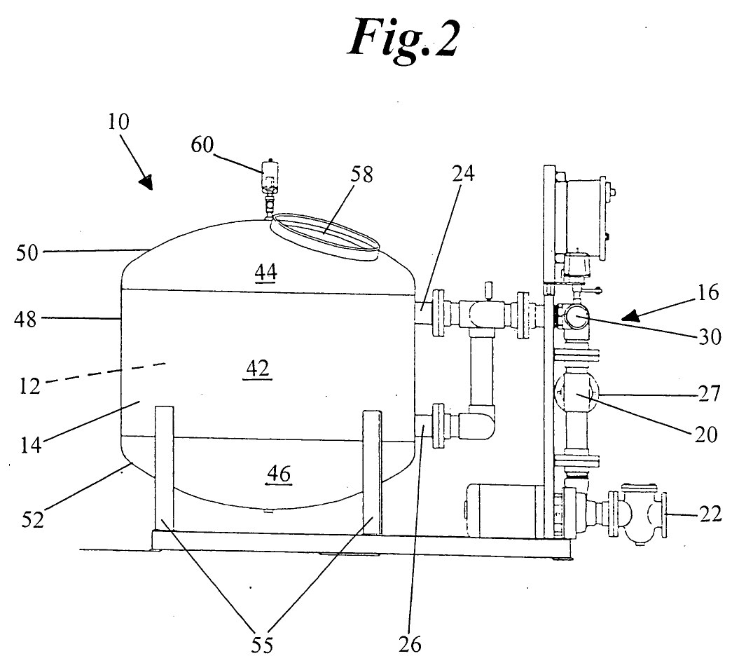

Referring now to the drawings, and particularly to FIGS. 1 and 2, a fluid treatment device 10 is shown comprising a filter media 12 contained within a housing 14. Process fluid, from a source such as, for example, a cooling tower, is passed downwardly through the media 12 in order to filter organic and inorganic matter from the process fluid.

A piping assembly 16 handles the process fluid for delivery to the treatment device 10, the treatment device effluent for returning to the cooling tower, or to some other location, and backwash fluid, when backwashing is being performed. Specifically, the piping assembly 16 includes a first manifold 20 and second manifold 21 and an actuator 23 having a plurality of three way valves to control flow into the following conduits: a process fluid conduit 22 for conveying process fluid from the source, an inlet conduit 24 for delivering process fluid to the device 10 for treatment, an outlet conduit 26 for carrying effluent from the treatment device 10 and for conveying backwash, a return conduit 28 for returning effluent for reuse by the source, and a waste conduit 30 (FIG. 2) for conveying backwash to a settling pond or other location for further treatment. For simplicity, components that are nonessential to the present invention such as extraneous valves, pumps, pressure gauges, and the like, are omitted from description as these elements are conventional and may be provided as necessary by the skilled practitioner in the art. Flow meters may also be provided as desired or required for proper operation of the treatment device 10.

An external conduit 27 is provided in the piping assembly 16, such that one can select the source of backwash fluid with which to flood the filter device. The external conduit 27 is integrally connected to the second manifold piping assembly 21 such that the selected external fluid backwash or process fluid backwash is directed through the outlet conduit 26 and into the treatment device 10.

The treatment device 10 floods with backwash fluid until the effluent level therein rises to the level of the inlet conduit 24. The effluent then flows out of the treatment device 10 through the inlet conduit 24. The backwashed effluent is then directed to the waste conduit 30, where it exits the piping assembly 16 to a holding tank, treatment pond, or the like.

The housing 14 defines a chamber having a cylindrical intermediate portion 42, a top portion 44 and a conical bottom portion 46, which are respectively defend by a circular side wall 48, a concave top wall 50 that closes the top of the housing 14, and a conical lower wall 52 that forms the bottom of the housing 14. These housing 14 portions are joined by conventional welding to hold the filter media 12. The housing 14 is supported on a suitable foundation, not shown, by a plurality of spaced columns 55, in conventional manner. Suitable cross braces, not shown, for the columns 55 may also be provided.

The intermediate portion 42 of the housing 14 may be of any suitable diameter, but in most applications the diameter will be between 2 feet and 3 feet. The housing 14 may also be of any suitable height, but typical will be between 5 feet and 7 feet so that the filter media 12 can be of sufficient depth. The depth of the filter media 12, for a given application, is determined by known engineering methods taking into account the degree of process fluid purification desired and the point of decreasing returns where excessive pumping pressures are encountered without great benefaction to fluid purity.

A loading port 58 is provided in the top of the housing 14 for loading filter media 12. Also provided in the top portion 44 of the housing 14 is an air release valve 60 for preventing inadvertent rupture of the housing 14 due to pressure changes during operation and backwashing. A cleanout port, not shown, is provided in the lower end of the housing 14 for filter media 12 removal under atypical scenarios wherein the filter media 12 has become contaminated or impacted.

The inlet conduit 24 is sealedly fixed through the circular side wall 48, preferably by welding, so that the process fluid conveyed there-through is introduced, preferably tangentially, into the housing 14 above the filter media 12. If tangential communication between the inlet conduit 24 and circular side wall 48 the fluid is caused to circularly swirl along the top of the filter media 12. There is sufficient freeboard between the inlet conduit 24 and the filter media 12 to accommodate swirling.

The filter media 12 comprises a gravel bed (not shown) which substantially fills the hemispherical bottom portion 46 of the housing 14 to a height above that of the exit conduit. A silica bed (not shown) which is supported by the gravel bed partially fills the intermediate portion 42 of the housing 14. Although different gravel and silica may be used, pea gravel sized ⅛ inch to ¼ inch is suitable, and the silica is preferably spherical with about a 0.35 mm diameter, or optionally, may have an irregular shape. The filter media 12 is preferably configured to remove particles that are at least 0.45 microns in size from process fluid as it passes downwardly there-through. Conventional engineering methods are used to properly select the size and packing density of the gravel and silica and, accordingly, to select the desired filter media removal efficiency.

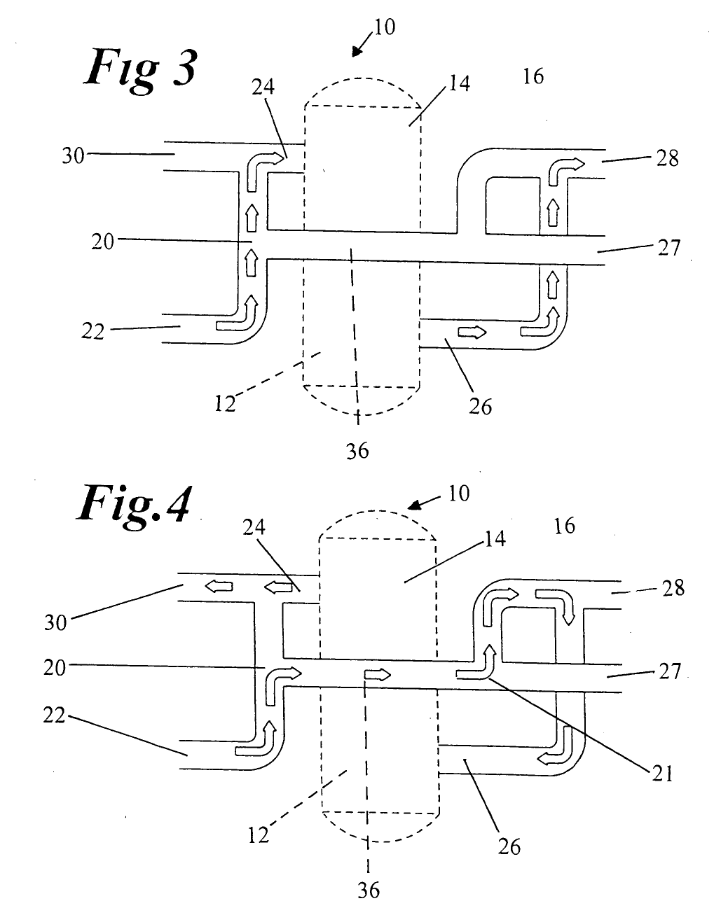

Normal flow of the process fluid through the piping apparatus is shown in FIG. 3. Fluid from the cooling tower or other application enters the piping apparatus 16 through the process fluid conduit 22. The process fluid then flows into the first manifold 20, where it is directed into the housing 14 of the treatment device 10 via the inlet conduit 24. The process fluid then percolates down through the filter media 12 contained by the treatment device 10. The now filtered fluid flows out of the housing 14 through the outlet conduit 26. The filtered fluid is then directed through the second manifold 21 and out of the piping assembly 16 through the return conduit 28, for reuse in the cooling tower or other application.

By introducing the process fluid tangentially into the treatment device 10, the fluid is caused to swirl above the silica bed. The swirling assists in preventing channeling through the filter media 12. Moreover, the velocity of the swirling fluid is greater near the peripheral than the center, disturbing the silica bed to become slightly coned shaped. The cone shape increases the effective surface area of the silica bed and, hence, its capacity to treat fluid. Overall, the swirling, in conjunction with the coned silica bed, enables the filter bed to operate at an increased flow rate of approximately 25 to 30 percent. The device 10 can be configured to treat various flow rates. Notwithstanding, it is expected that a common treatment capacity of the present invention will be about 25-30 gals/min/ft².

Swirling the process fluid is also advantageous in that it imparts a centripetal force component to the flow whereby suspended solids are forced outwardly to the circular sidewall 48 where a percentage of the suspended solids are kept in suspension. By temporarily or permanently keeping solids in suspension, fewer particles become deeply embedded in the filter media 12 or in the interstitial spacing of the media 12. Accordingly, upon backwashing, suspended solids quickly separate from the filter media 12. Since particles are more efficiently removed from the filter media 12, significantly less backwash fluid, in the range of about 50-60 percent, is required than with conventional filters of similar treatment capacity. This efficiency difference exists because traditional filters linearly introduce fluid through a filter media 12 which drives the particles deeply into the media 12 where they become impacted. Consequently, greater backwash flow is required to remove particles from the interstitial spaces deep within the filter media 12.

Initially, process fluid is tangentially fed into the treatment device 10 through the inlet conduit 24 to impart a swirling motion to the process fluid above the upper surface of the silica bed. The swirling fluid causes the silica bed to become coned, increasing the silica bed's effective surface area. Since the surface area is enlarged, the rate in which the silica bed can treat the process fluid is increased.

Additionally, by causing the process fluid to swirl, a percentage of the suspended solids is maintained in suspension above the silica bed while the process fluid passes downward through the filter media 12 where the remaining solids are stripped out from the process fluid. Hence, swirling the process fluid reduces particulate matter loading to the filter media 12, and reduces the amount of particles that would have become deeply imbedded or impacted in the filter media 12. Upon passing through the filter media 12, the purified fluid egresses the housing 14 through outlet conduit 26 disposed at the bottom of the housing 14. The cleansed effluent is returned to the cooling tower for reuse.

In order to effectuate backwashing, flow is reversed through the treatment device 10 so that process fluid, external fluid, or collected effluent, flows into the device 10 through the outlet conduit 26, is forced upwardly through the filter media 12, then exits the housing 14 through the inlet conduit 24 for proper disposal. As an example, for the device 10 to treat 25-30 gals/min/ft², backwash fluid is introduced into the filter media 12 at a preferred rate of about 25 gal/min/ft² to fully fluidized the filter media 12 and to carry particles having a specific gravity that is less than that of gravel and silica from the housing 14. The freeboard within the housing 14 between the upper surface of the silica bed and the inlet conduit 24 is sufficient to enable settling of any silica which may be carried up by the rising backwash fluid. The frequency of backwashing can be controlled by a pressure switch, timer or manually actuated. When using a pressure switch, the preferred pressure drop is approximately 5-12 pounds/inch².

As backwash fluid is passed upwardly through the filter media 12, particles with a lower specific gravity than that of gravel or silica are carried through the filter media 12 and egress the housing 14 via the inlet conduit 24 for proper disposal. There is sufficient freeboard between the silica bed and the inlet conduit 24 to allow silica, which have become entrained in the backwash, to settle back to the silica bed.

Complete fluidization of the filter media 12 during backwash is preferred in order to thoroughly clean the media 12 of imbedded particles, re-stratify the filter media 12 and to break any bonding of the media 12 (for example, calcification from hard fluid). If the filter media 12 is not completely fluidized during backwashing, the filter media 12 may see no flow or minimal flow conditions. At these low flow areas, captured particles are not removed and the media 12 is not fully re-stratified. No flow conditions combined with non-removed foreign particles are detrimental since they provide a breeding ground for bacteria. Furthermore, an unfluidized filter media 12 becomes compacted, reducing the treatment capacity of the treatment device, and thus requiring replacement.

Complete fluidization of the filter media 12 includes the steps of lifting the entire filter media 12 from its fully packed condition and allowing it to expand at least 30 percent. This allows gravel, silica and captured particle to break free from neighboring matter.

Under typical loading conditions, the backwashing method of the present invention is so effective at removing particulate matter that significant bacteria growth does not occur in the filter media 12. Additionally, a flocking agent is not typically required since the treatment device 10 removes suspended solids at such a high efficiency. Notwithstanding the superior performance of the treatment device 10, under certain situation it may be desirable to provide chlorine or bromine for bacteria treatment, or a flocking agent, such as alum. As such, known automated or manual devices can be added to the fluid treatment device 10.

When utilizing process fluid backwash as exemplified in FIG. 4, the process fluid flows in through the process fluid conduit 22. Through the use of a series of actuators 23, the fluid flow is directed across a check valve 36. In normal operation, the check valve 36 remains in a closed position, with the process fluid not exerting enough pressure upon it to cause the valve to open. However, when utilizing external fluid in the backwash configuration, the process fluid is physically blocked from its normal course of flow from the process fluid conduit 20 into the inlet conduit 24. The pressure inside the piping assembly 16 increases as more process fluid is forced in therein. This pressure increase causes the check valve 36 (not shown) to open. The process fluid can then flow from the process conduit 20 into the outlet conduit 26, and enter the treatment device 10 from the reverse direction. Note that the return conduit 28 has also been blocked in this configuration, by a corresponding actuator movement to that described previously. The process fluid flows from the second manifold 21 into the outlet conduit 26 where it enters the treatment device 10. The treatment device 10 then floods until the effluent level therein rises to the level of the inlet conduit 24. The effluent then flows out of the treatment device 10 through the inlet conduit 24. The backwashed effluent is then directed to the waste conduit 30, where it exits the piping assembly 16 to a holding tank, treatment pond, or the like.

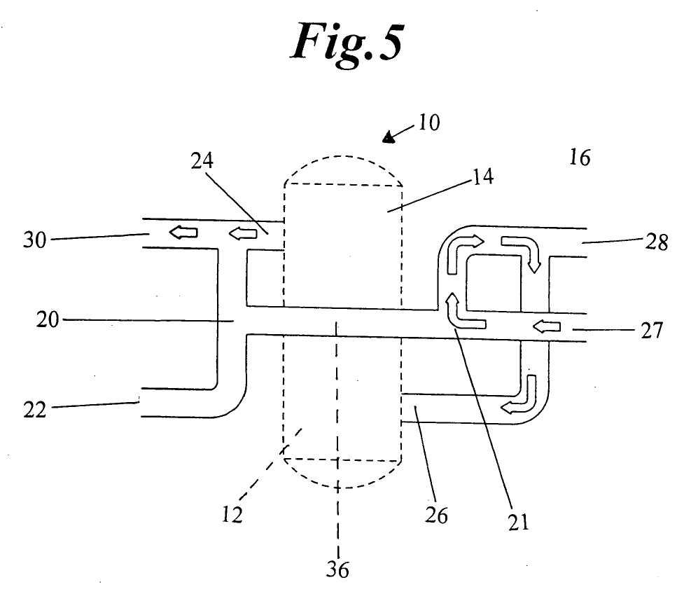

As shown in FIG. 5, when utilizing the external fluid for the backwash media, external fluid is allowed to enter the piping apparatus 16 from the external conduit 27 where it is then directed into the manifold 20. The one-way check valve 36 (not shown) prevents the external fluid from flowing back through the process fluid conduit 22, and into the cooling tower. The external fluid flows from the second manifold 21 where it is directed by the actuator 23 (not shown) into the outlet conduit 26 where it enters the treatment device 10. The treatment device 10 then floods until the effluent level therein rises to the level of the inlet conduit 24. The effluent then flows out of the treatment device 10 through the inlet conduit 24. The backwashed effluent is then directed to the waste conduit 30, where it exits the piping assembly 16 to a holding tank, treatment pond, or the like.

### SUMMARY OF THE ACHIEVEMENT OF THE OBJECTS OF THE INVENTION

From the foregoing, it is readily apparent that we have invented a piping apparatus for use with a fluid treatment device having a filter media for purifying process fluid. The piping apparatus allows for easy selection between a plurality of backwash sources, preferably between an internal or process fluid source, and an external or external fluid source.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A fluid treatment device, comprising:
a. a housing;
b. a filter media disposed within said housing; and
c. a piping apparatus comprising a plurality of backwash connections and both an inlet conduit and an outlet conduit that connect said piping apparatus to said housing in a manner that allows for easy conversion between said plurality of backwash connections, said inlet and outlet conduits being adapted to receive and direct a fluid into said housing in either a normal flow or a backwash flow configuration.

2. The fluid treatment device of claim 1, wherein said inlet conduit is tangentially connected to said housing causing said fluid to swirl above said filter media.

3. The fluid treatment device of claim 1, wherein said backwash connections comprise both a external fluid conduit and a process fluid conduit through which fluid can enter said piping apparatus.

4. The fluid treatment device of claim 3 further comprising a source of external fluid and a source of process fluid, wherein said external fluid conduit is connected to a external fluid supply and said process fluid conduit is connected to a process fluid supply.

5. The fluid treatment device of claim 4, wherein said piping apparatus includes means for switchably selecting between said external fluid supply and said process fluid supply.

6. The fluid treatment device of claim 3, wherein said piping apparatus further comprises a valve to prevent fluid from flowing from said external fluid conduit through said piping assembly, and out from said process fluid conduit.

7. The fluid treatment device of claim 6, wherein said valve is a one-way check valve.

8. The fluid treatment device of claim 1, wherein said filter media is selected from the groups consisting of silica, diatomaceous earth, gravel, or any combination thereof.

9. The fluid treatment device of claim 8, wherein said filter media comprises stratified gravel and silica.

10. The fluid treatment device of claim 9, wherein said housing comprises a conical portion that is substantially filled with said stratified gravel of said filter media.

11. A piping assembly to be used with a fluid treatment device, said piping assembly comprising an inlet conduit, an outlet conduit, and a plurality of backwash connections capable of switchable selection between a said plurality of backwash connections.

12. The piping assembly of claim 11 wherein said plurality of backwash connections comprise a process conduit and a external conduit.

13. The piping assembly of claim 12, further comprising at least one actuator, wherein said at least one actuator is adapted to selectively direct fluid flow from said external conduit or said process conduit into said outlet conduit in order to backwash a fluid treatment device.

14. The piping assembly of claim 12 further comprising a valve to prevent fluid from flowing from said external conduit through said piping assembly, and out through said process conduit when backwashing with effluent from said external conduit.

15. The piping assembly of claim 14, wherein said valve is a check valve.

16. The piping assembly of claim 15 further comprising a fluid treatment device, wherein said inlet conduit is tangentially connected to said fluid treatment device, causing a fluid to swirl above said filter media.

17. A process for backwashing a filtration treatment device, comprising the steps of:
a. providing a housing;
b. providing a filter media within said housing;
c. providing a piping apparatus comprising both an inlet conduit and an outlet conduit that connect said piping apparatus to said housing, said piping apparatus having a plurality of backwash connections that are connected to a plurality of backwash sources, said piping apparatus allowing for easy conversion between said plurality of backwash sources; and
d. switchably selecting between said plurality of backwash sources.

18. The process for backwashing a filtration device according to claim 17, further comprising the steps of providing a backwash fluid from at least one of said plurality of backwash sources for the purpose of backwashing said filter media.

19. The process for backwashing a filtration device according to claim 19, said backwash connections further comprising a process conduit and a external conduit for conveying a backwash fluid into said housing for the backwash of said filter media.

20. The process for backwashing a filtration device according to claim 17, wherein the piping apparatus further comprises a control panel and at least one monitoring device, said monitoring device being adapted for determining the need for a backwash cycle.

21. The process for backwashing a filtration device according to claim 20, wherein the monitoring device is a conductivity meter.

22. The process for backwashing a filtration device according to claim 20, wherein the control panel is adapted to automatically select between said plurality of backwash sources, and trigger a backwash cycle based on a value from the monitoring device.
